(19) United States
(12) Patent Application Publication
(10) Pub. No.: US 2008/0025706 A1
(43) Pub. Date: Jan. 31, 2008

(54) Information recording apparatus and control method thereof

(75) Inventors: Kenji Yoshida, Akishima-shi (JP); Yoriharu Takai, Kodaira-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/826,150

(22) Filed: Jul. 12, 2007

(30) Foreign Application Priority Data
Jul. 25, 2006 (JP) 2006-202382

(51) Int. Cl. H04N 5/00

(52) U.S. Cl. 386/125; 386/E09.001

(57) ABSTRACT

According to one embodiment, when a command which requests to specify addresses and cancel pinned attribute information is input, the address to which the pinned attribute information is assigned is changed so that unpinned attribute information is associated with this address, among the addresses specified by the command. This permits information in an area corresponding to the address specified by the command to be written into a disk-shaped recording medium when executing a function of writing, into the disk-shaped recording medium, data in an area corresponding to the address of the unpinned attribute information in a cache memory.

### CROSS-REFERENCE TO RELATED APPLICATIONS

This application is based upon and claims the benefit of priority from Japanese Patent Application No. 2006-202382, filed Jul. 25, 2006, the entire contents of which are incorporated herein by reference.

### BACKGROUND

1. Field

One embodiment of the invention relates to an information recording apparatus which uses a nonvolatile semiconductor memory as a cache to write information (data) on a high-capacity disk-shaped recording medium such as a hard disk, and a control method thereof.

2. Description of the Related Art

As is well known, a hard disk is a high-capacity and highly reliable information recording medium, and has recently been widely used in many fields to record, for example, computer data, image data, audio data, etc. Moreover, the shapes of the hard disks are so reduced in size that the hard disks are installed in portable electronic devices.

Consequently, in regard to information recording apparatuses using the hard disks and oriented to the size reduction, there is at present an idea of using nonvolatile semiconductor memories which permit high-speed writing and reading of information as memory caches for the hard disks to increase the speed of writing and reading information, and reducing the number of times that the hard disk is driven, that is, the number of times that information is written into and read from the hard disk to save the power of batteries.

That is, in the information recording apparatus of this kind, the nonvolatile memory writes and read information into and from the outside, while information is transferred between the hard disk and the nonvolatile memory, such that the speed of the information writing and reading operation is increased when viewed from the outside, and the number of times that the hard disk is driven is reduced. Thus, such an information recording apparatus is also referred to as a nonvolatile (NV)-cache compliant hard disk drive (HDD), and is standardized.

Here, regarding the information recording apparatus in which the speed of the information writing and reading operation is increased and the number of times that the hard disk is driven is reduced, there is an idea of using a flash memory as the nonvolatile memory serving as a cache. Meanwhile, the flash memory is limited in the number of times (e.g., one hundred thousand times) that it permits rewriting, and has such a nature that an error is more likely to occur and reliability decreases if this limited is exceeded.

Therefore, in the information recording apparatus using the nonvolatile memory as a cache to record information on the hard disk, it is strongly desired not only to reduce the number of times that the hard disk is driven to save more power, but also to make improvements so that the information writing and reading operation is efficiently controlled in consideration of the limit of the number of rewriting in the nonvolatile memory, the ease of use for a user, etc.

Jpn. Pat. Appln. KOKAI Publication No. 2004-55102 has disclosed a high-capacity storage medium equipped with both a memory card and an HDD. This high-capacity storage medium is capable of backing up, for example, data in the memory card acquired from the outside on the hard disk which is a magnetic recording medium, and transferring data in the hard disk to the memory card and taking the data from the memory card.

Furthermore, Japanese Patent No. 3407317 has disclosed a portable storage device using a flash memory. Japanese Patent No. 3407317 provides a data management method which holds down the increase of the number of rewriting in, for example, a particular area alone in order to solve the problem that an error more easily occurs if the number of rewriting (e.g., one hundred thousand times) in the flash memory increases.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block configuration diagram showing one embodiment of this invention to explain the outline of an information recording apparatus;

FIG. 2 is a diagram shown to explain one example of a management table of a flash memory used in the information recording apparatus in the embodiment;

FIG. 3 is a block diagram shown to explain one example of a controller used in the information recording apparatus in the embodiment;

FIG. 4 is a block diagram shown to explain one example of a host device connected to the information recording apparatus in the embodiment;

FIG. 5 is a flowchart shown to explain one example of the processing operation of the controller in the embodiment;

FIG. 6 is a diagram shown to explain another example of the management table of LBAs used in the information recording apparatus in the embodiment; and

FIG. 7 is a diagram shown to explain still another example of the management table of the LBAs used in the information recording apparatus in the embodiment.

### DETAILED DESCRIPTION

Various embodiments according to the invention will be described hereinafter with reference to the accompanying drawings. In general, according to one embodiment of the invention, when a command which requests to specify addresses and cancel pinned attribute information is input, the address to which the pinned attribute information is assigned is changed so that unpinned attribute information is associated with this address, among the addresses specified by the command. This permits information in an area corresponding to the address specified by the command to be written into a disk-shaped recording medium when executing a function of writing, into the disk-shaped recording medium, data in an area corresponding to the address of the unpinned attribute information in a cache memory.

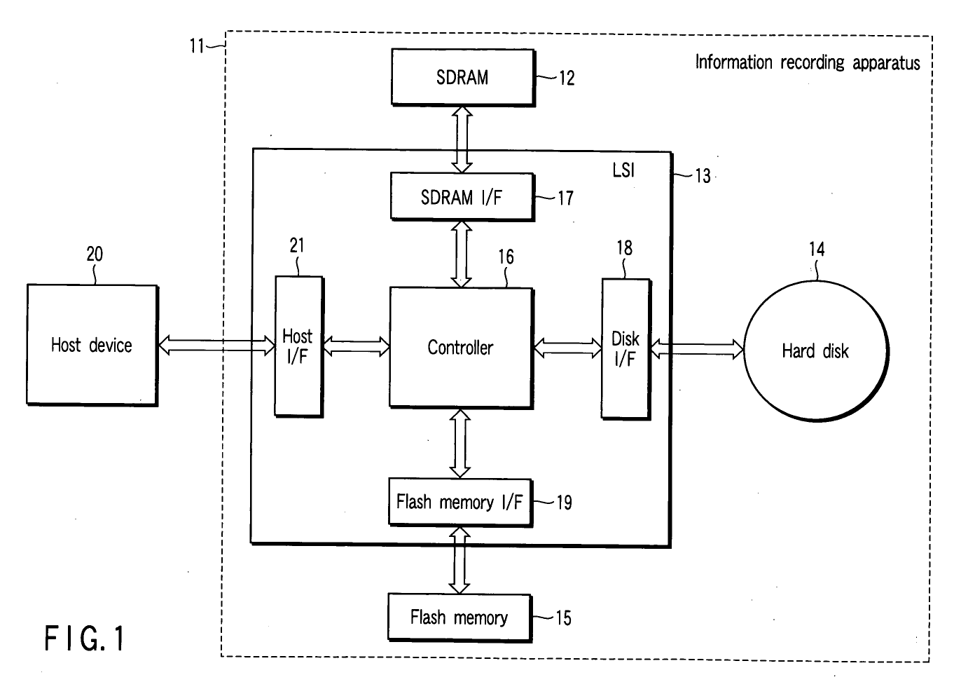

FIG. 1 shows the outline of an information recording apparatus 11 described in this embodiment. The information recording apparatus 11 described here is intended for an NV-cache compliant HDD standardized by, for example, Non Volatile Cache Command Proposal for ATA8-ACS Revision 5.

That is, this information recording apparatus 11 comprises an SDRAM 12 functioning as a buffer, a one-chip LSI 13 having various circuit blocks therein, a hard disk 14 which is a high-capacity disk-shaped recording medium, a flash memory 15 which is a nonvolatile memory functioning as a cache for the hard disk 14, etc.

Among these components, the LSI 13 has a controller 16 therein, and this controller 16 serves as a control unit which takes overall control of the information recording apparatus 11 when the information recording apparatus 11 performs various kinds of processing operation. Further, this LSI 13 has therein an SDRAM interface (I/F) 17 which connects the controller 16 to the SDRAM 12 to enable the transfer of information, a disk I/F 18 which connects the controller 16 to the hard disk 14 to enable the transfer of information, a flash memory I/F 19 which connects the controller 16 to the flash memory 15 to enable the transfer of information, a host I/F 21 which connects the controller 16 to an external host device 20 to enable the transfer of information, etc.

Here, the host device 20 is, for example, a personal computer (PC). This host device 20 uses the information recording apparatus 11 to write and read information (data) when executing, for example, predetermined application software, and can also use the information recording apparatus 11 as a saving destination of the information finally obtained.

In this case, the host device 20 generates, for the information recording apparatus 11, a command to request the writing of information or a command to request the reading of information. These commands are supplied to the controller 16 via the host I/F 21 and analyzed.

Thus, the controller 16 controls the SDRAM 12, the flash memory 15, the hard disk 14, etc. so that they selectively executes the writing of the information supplied from the host device 20, the reading of the information from the host device 20, etc. In addition, the controller 16 has a function of enabling the transfer of information among the SDRAM 12, the flash memory 15 and the hard disk 14.

Basically, the controller 16 causes the flash memory 15 to record the information to be written, when receiving an information write request from the host device 20. Then, for example, when the recording area of the flash memory 15 is used to a certain degree or more, the controller 16 causes the information recorded in the flash memory 15 to be transferred to and saved in the hard disk 14 with predetermined timing.

Furthermore, when receiving an information read request from the host device 20, the controller 16 causes the requested information to be read from the hard disk 14 and output to the host device 20. In this case, if the requested information is present on the flash memory 15, the controller 16 causes the information to be read from the flash memory 15 and output to the host device 20.

Herein, an error correcting code is added to the information (data) written into the flash memory 15. Moreover, the data read from the flash memory 15 is subjected to error correcting processing based on the error correcting code.

Furthermore, an error correcting code is also added to the data recorded in the hard disk 14. Moreover, the data read from the hard disk 14 is subjected to error correcting processing based on the error correcting code.

In this embodiment, the flash memory 15 is set to an information writing and reading unit of, by way of example, 2 Kbytes. Further, the flash memory 15 is set to an information erasure unit of 128 Kbytes. Moreover, in the flash memory 15, elements deteriorate and the rate of error occurrence rises as the number of times that information is written into and read from the flash memory 15 increases. Therefore, the number of information rewriting is set to about one hundred thousand to ensure the performance of the elements.

Here, there will be described commands necessary in the explanation of this embodiment among various commands set by the above-mentioned standard and executable by the information recording apparatus 11. Initially, a first command specifies a logical block address (LBA) for writing information into the flash memory 15 out of LBAs on the hard disk 14.

Furthermore, a second command specifies an LBA for writing information into the flash memory 15 similarly to the first command. At the same time, the second command requests to read the information recorded at the LBA from the hard disk 14 and write the read information in the flash memory 15.

The first and second commands described above correspond to PI=0 and PI=1 of “Add LBA(s) to NV Cache Pinned Set” in the above-mentioned standard. Attribute information called pinned is assigned to the LBA indicated by the host device 20 to store information in the flash memory 15.

That is, in the case of the first and second commands, an area on the flash memory 15 is allocated to the LBA indicated by the host device 20 to read from or write into the flash memory 15, and the LBA indicated by the host device 20 is associated with the pinned attribute information in the allocated area on the flash memory 15.

A third command specifies an LBA on the hard disk 14 to request the writing of information. When the third command is generated from the host device 20, the controller 16 checks whether the pinned attribute information is associated with the LBA at which writing is requested. When the pinned attribute information is associated with this LBA, information is written into the corresponding area of the flash memory 15. When the pinned attribute information is not associated with the LBA at which writing is requested, a decision is made at the discretion of the controller 16 as to whether information is written into the flash memory 15 or the specified LBA of the hard disk 14, and the decided action is taken.

A fourth command specifies an LBA on the hard disk 14 to request the reading of information. When the fourth command is generated from the host device 20, the controller 16 needs to read information from the flash memory 15 in the case where it is judged that an area corresponding to the LBA in question has already been allocated onto the flash memory 15 and that the information newer than that on the hard disk 14 is saved on the flash memory 15. When the same information is present on the hard disk 14 and the flash memory 15, this information may be read from the flash memory 15 or may be read from the specified LBA in the hard disk 14. Moreover, when an area corresponding to the LBA in question has already been allocated onto the flash memory 15 but up-to-date data is present on the hard disk 14, this information has to be read from the hard disk 14. Then, when the information is read from the hard disk 14, the controller 16 also judges whether to cache the information in the flash memory 15.

Attribute information called unpinned is assigned to the LBA to which an area is allocated on the flash memory 15 and at which information is written into the allocated area on the flash memory 15, among the LBAs with which the pinned attribute information is not associated out of the LBAs at which the writing or reading of information is requested by the third and fourth commands as described above.

That is, in the case of the third and fourth commands, an area on the flash memory 15 is allocated to the LBA which is not associated with the pinned attribute information with regard to some or all commands in which the LBA indicated for reading or writing is not associated with the pinned attribute information among commands issued from the host device 20 to request reading or writing. Then, the LBA indicated by the command issued from the host device 20 to request reading or writing is associated with unpinned attribute information in the allocated area on the flash memory 15.

A fifth command requests to create a free area of a specified size in the flash memory 15. When the fifth command is generated from the host device 20, the controller 16 moves information equal to or more than a specified size to the hard disk 14 from the area corresponding to the LBA in the flash memory 15 to which the unpinned attribute information is assigned in the case where a current free area is smaller than the requested free area. Thus, the free area of the specified size is secured in the flash memory 15. In this case, the judgment of the controller 16 decides from which area corresponding to the LBA in the flash memory 15 to which the unpinned attribute information is assigned the information is to be moved to the hard disk 14, that is, decides in which area of the flash memory 15 a free area is to be formed.

A sixth command requests to specify an LBA to cancel the pinned attribute information (set the attribute information so that it is not the pinned), and is referred to as “Remove LBA(s) From NV Cache Pinned Set” in the above-mentioned standard. When the sixth command is generated from the host device 20, the controller 16 needs to transfer to and write into the hard disk 14 the information stored in the area corresponding to the LBA in the flash memory 15 specified by the sixth command, but the timing of this operation is not specified in the above-mentioned standard.

In this case, if the timing is set so that the information stored in the flash memory 15 is written into the hard disk 14 instantly when the sixth command is generated, a motor has to be started every time to rotate the hard disk 14 when the hard disk 14 is not rotating at the moment, which leads to an increase in the number of times that the hard disk 14 is driven and to an increase in power consumption.

On the other hand, the controller 16 is equipped with a function to automatically transfer to and write into the hard disk 14 the information stored in the area corresponding to the LBA in the flash memory 15 to which the unpinned attribute information is assigned, when the flash memory 15 is full or when the free space in the flash memory 15 has reached a predetermined capacity set in advance. This makes it possible to always secure a free area in the flash memory 15 so that the information write request made to the information recording apparatus 11 from the outside can be handled.

Therefore, in this embodiment, in the case where the hard disk 14 is not rotating when the sixth command is generated, the controller 16 controls to change the LBA to which the pinned attribute information is assigned among the specified LBAs so that the unpinned attribute information is associated with this LBA instead of the pinned attribute information. This can be easily achieved by rewriting a management table described later for managing the LBAs.

Thus, when the controller 16 transfers to and writes into the hard disk 14 the information stored in the area corresponding to the LBA in the flash memory 15 to which the unpinned attribute information is assigned in order to secure a free space in the flash memory 15, the information stored in the area in the flash memory 15 corresponding to the LBA specified by the sixth command is transferred to and written into the hard disk 14 together. This makes it possible to reduce the number of times that the hard disk 14 is driven and to save power.

Furthermore, in order to secure a free space in the flash memory 15 as described above, the controller 16 controls to sequentially transfer to and write into the hard disk 14 the information stored in the areas corresponding to the LBAs whose access dates are oldest out of the areas corresponding to the LBAs in the flash memory 15 to which the unpinned attribute information is assigned.

Therefore, when the sixth command is generated, the controller 16 changes the LBA to which the pinned attribute information is assigned among the specified LBAs so that the unpinned attribute information is assigned thereto, and assigns attribute information indicating the oldest access date to the LBA changed to the unpinned attribute information (this can also be achieved by rewriting the management table for the LBAs). Then, the information stored in the area in the flash memory 15 corresponding to the LBA changed to the unpinned attribute information by the sixth command can be preferentially transferred to and written into the hard disk 14.

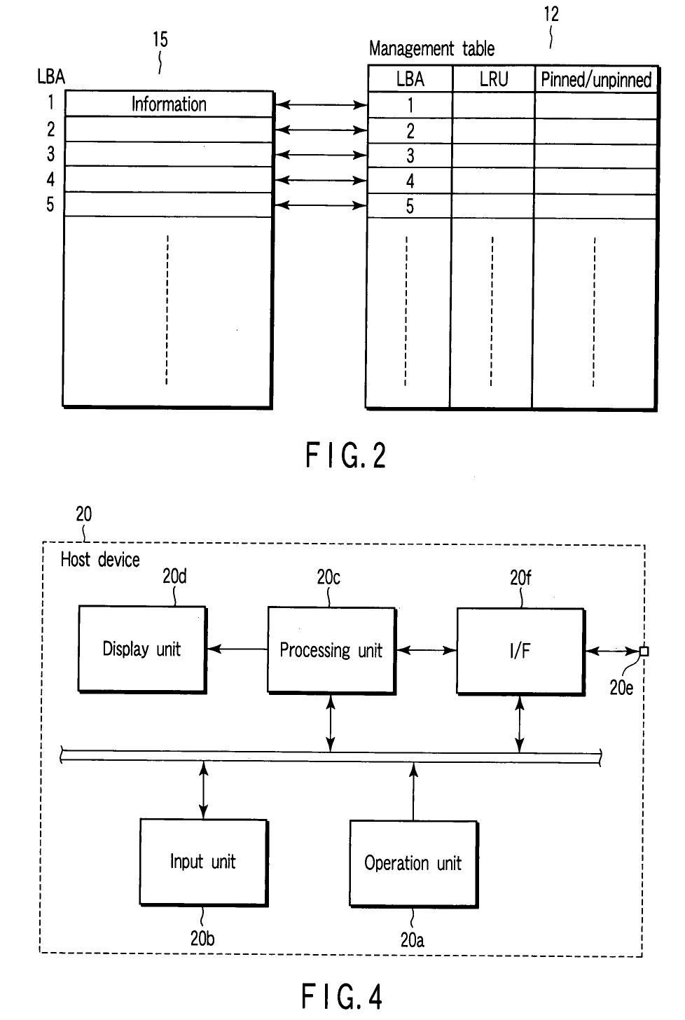

FIG. 2 shows one example of the management table for managing the attribute information added to the LBAs. This management table is stored in, for example, the SDRAM 12. In this management table, items indicating LRU (least recently used) and items indicating pinned/unpinned are associated with the respective LBAs.

Of these items, the LRU is information indicating the LBA whose access date is oldest. Further, the pinned/unpinned is information indicating whether the pinned attribute information or the unpinned attribute information is presently assigned to the LBA.

Then, in the case where the hard disk 14 is not rotating when the sixth command is generated, the controller 16 controls to rewrite the pinned/unpinned of the LBA whose attribute information is set to pinned among the LBAs specified by the sixth command so that the attribute information is set to unpinned.

Then, when the controller 16 moves to the hard disk 14 the information stored in the area corresponding to the LBA in the flash memory 15 to which the unpinned attribute information is assigned in order to secure a free space in the flash memory 15, the information stored in the area in the flash memory 15 corresponding to the LBA specified by the sixth command is transferred to and written into the hard disk 14 together. This makes it possible to reduce the number of times that the hard disk 14 is driven and to save power.

Moreover, the pinned/unpinned in the management table can include information indicating whether a change has been made from pinned to unpinned in the case of unpinned.

Then, in the case where the hard disk 14 is not rotating when the sixth command is generated, the controller 16 controls to rewrite the pinned/unpinned of the LBA whose attribute information is set to pinned among the LBAs specified by the sixth command so that the attribute information is set to the information indicating that a change has been made from pinned to unpinned.

Then, when moving to the hard disk 14 the information stored in the area corresponding to the LBA in the flash memory 15 to which the unpinned attribute information is assigned in order to secure a free space in the flash memory 15, the controller 16 controls to preferentially transfer to and write into the hard disk 14 the information in the area corresponding to the LBA changed from pinned to unpinned among the LBAs set to unpinned. This makes it possible to preferentially transfer to and write into the hard disk 14 the information stored in the area in the flash memory 15 corresponding to the LBA specified by the sixth command.

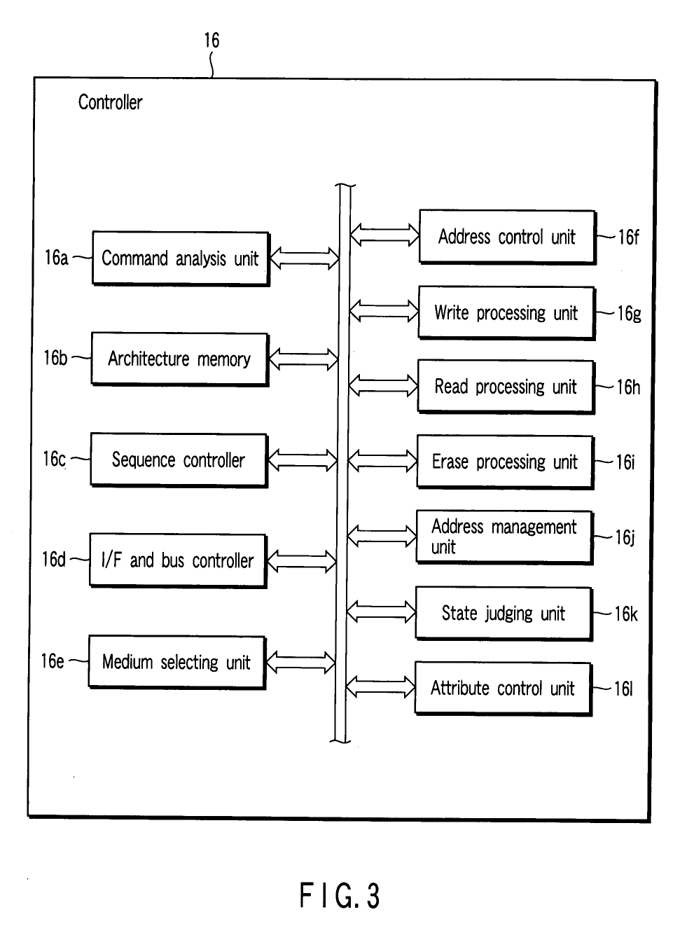

FIG. 3 shows one example of the controller 16. This controller 16 has a command analysis unit 16a for decoding and analyzing the command supplied from the host device 20. As a result of the analysis by the command analysis unit 16a, software in an architecture memory 16b is specified, and an operation procedure is set in a sequence controller 16c.

This sequence controller 16c controls the flow of the information via an I/F and bus controller 16d. For example, when information is written or read, a medium selecting unit 16e specifies the flash memory 15 or the hard disk 14, and an address control unit 16f specifies a write address or read address.

Then, during the writing of information, a write processing unit 16g executes the transfer processing, etc. of the information to be written. During the reading of information, a read processing unit 16h executes the transfer processing, etc. of the information to be read.

The controller 16 is further provided with an erase processing unit 16i. This erase processing unit 16i erases the information recorded in the flash memory 15. The erase processing unit 16i can also erase the information recorded in the hard disk 14.

The controller 16 is still further provided with an address management unit 16j. This address management unit 16j collectively manages the addressees of recorded areas, unrecorded areas, etc. in the flash memory 15 and the hard disk 14. Further yet, the controller 16 is provided with a state judging unit 16k for monitoring the driving state of the hard disk 14.

Moreover, the controller 16 is provided with an attribute control unit 16l. This attribute control unit 16l creates information such as the LRU and pinned/unpinned to be written into the management table.

FIG. 4 shows one example of the host device 20. This host device 20 has an operation unit 20a operated by a user, and an input unit 20b for acquiring information from an external network and a predetermined information recording medium in accordance with the operation of the operation unit 20a.

Furthermore, this host device 20 has a processing unit 20c for subjecting the information acquired in the input unit 20b to predetermined signal processing and generating a command for the information recording apparatus 11, and a display unit 20d for displaying the results of the processing in the processing unit 20c.

Still further, this host device 20 has an I/F 20f, and this I/F 20f outputs information and a command which are the results of the processing in the processing unit 20c to the external (information recording apparatus 11) via a connection terminal 20e, and supplies the information input from the external (information recording apparatus 11) via the connection terminal 20e to the processing unit 20c.

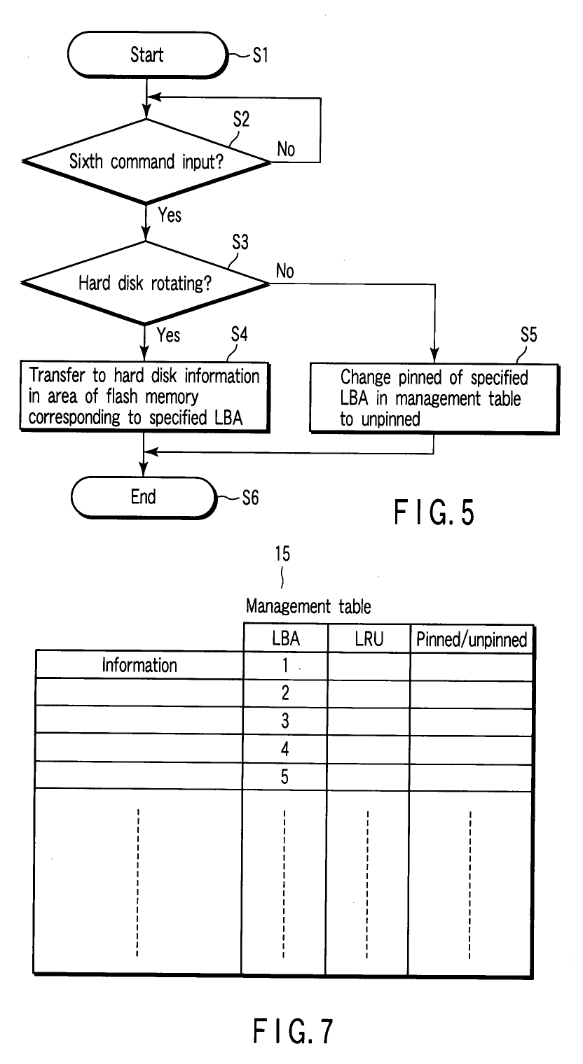

FIG. 5 shows one example of the processing operation in which the controller 16 automatically rewrites the attribute information in the management table when the sixth command is generated. That is, when the processing is started (step S1), the controller 16 judges in step S2 whether the sixth command is input.

When the sixth command is input (YES), the controller 16 judges in step S3 whether the hard disk 14 is rotating. When the hard disk 14 is rotating (YES), the controller 16 transfers to and writes into the hard disk 14 in step S4 the information stored in the area corresponding to the LBA in the flash memory 15 specified by the sixth command, and then terminates the processing (step S6).

When it is judged in step S3 that the hard disk 14 is not rotating (NO), the controller 16 rewrites in step S5 the pinned/unpinned of the LBA whose attribute information is set to pinned among the LBAs specified by the sixth command in the management table so that the attribute information is set to unpinned, and then terminates the processing (step S6).

As has been described above, when the controller 16 moves to the hard disk 14 the information stored in the area corresponding to the LBA in the flash memory 15 to which the unpinned attribute information is assigned in order to secure a free space in the flash memory 15, the information stored in the area in the flash memory 15 corresponding to the LBA specified by the sixth command is transferred to and written into the hard disk 14 together. This makes it possible to reduce the number of times that the hard disk 14 is driven and to save power.

Furthermore, in step S5, if the pinned/unpinned of the LBA whose attribute information is set to pinned among the LBAs specified by the sixth command is rewritten so that the attribute information is set to the information indicating that a change has been made from pinned to unpinned, the information stored in the area in the flash memory 15 corresponding to the LBA specified by the sixth command can be preferentially transferred to and written into the hard disk 14.

Still further, in step S5, if the pinned/unpinned of the LBA whose attribute information is set to pinned among the LBAs specified by the sixth command is rewritten so that the attribute information is set to unpinned or set to the information indicating that a change has been made from pinned to unpinned, and if the LRU corresponding to the specified LBA is rewritten to information indicating that the access date is oldest, the information stored in the area in the flash memory 15 corresponding to the LBA specified by the sixth command can be more preferentially transferred to and written into the hard disk 14.

In addition, in the operation described above, the pinned/unpinned of the LBA whose attribute information is set to pinned among the LBAs specified by the sixth command is rewritten so that the attribute information is set to unpinned when the hard disk 14 is not rotating. However, this also includes the case where the hard disk 14 is about to stop rotating.

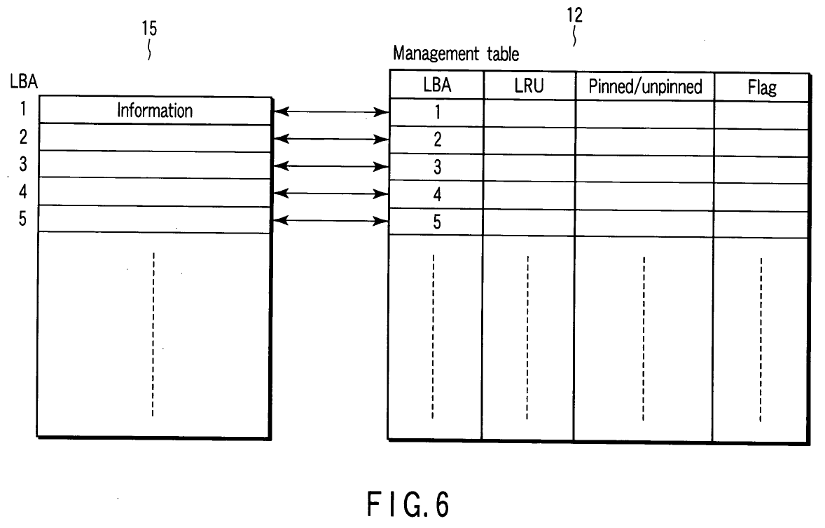

Here, in the embodiment described above, the controller 16 rewrites the LRU and the pinned/unpinned in the management table when the sixth command is input. However, this is not a limitation, and flags are newly provided in the management table to correspond to the LBAs, as shown in FIG. 6. The flags indicate whether the LBAs are specified by the sixth command.

Then, when the controller 16 moves to the hard disk 14 the information stored in the area corresponding to the LBA in the flash memory 15 to which the unpinned attribute information is assigned in order to secure a free space in the flash memory 15, the controller 16 operates to transfer to and write into the hard disk 14 together the information in the area corresponding to the LBA whose flag indicates that it is the LBA specified by the sixth command. Such a configuration also makes it possible to reduce the number of times that the hard disk 14 is driven and to save power.

Furthermore, in the embodiment described above, the management table is formed in the SDRAM 12 separate from the flash memory 15. However, this is not a limitation, and the management table may be formed in the flash memory 15 so that the information indicating the LRU and the information indicating the pinned/unpinned (the above-mentioned flags may be included) are written to correspond to the LBAs, as shown in FIG. 7.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording apparatus comprising:
an input unit configured so that a command is input thereto;
a disk-shaped recording medium;
a nonvolatile memory configured to serve as a cache memory for the disk-shaped recording medium;
a creating unit configured to create a management table wherein an area on the nonvolatile memory is allocated to an address indicated by a host to read from or write into the nonvolatile memory, the address indicated by the host is associated with pinned attribute information in the allocated area on the nonvolatile memory, an area on the nonvolatile memory is allocated to an address which is not associated with the pinned attribute information with regard to some or all commands in which the address indicated to read or write is not associated with the pinned attribute information among commands issued from the host to request reading or writing, and the address indicated by the command issued from the host to request reading or writing is associated with unpinned attribute information in the allocated area on the nonvolatile memory;
a recording unit configured to record, in the disk-shaped recording medium with predetermined timing, part or all of data in the area with which the unpinned attribute information is associated in the nonvolatile memory; and
a control unit configured to change an address with which the pinned attribute information is associated out of the specified addresses in the management table so that the unpinned attribute information is associated with this address, on the basis of a command from the host which requests to specify addresses and cancel the pinned attribute information.

2. An information recording apparatus according to claim 1, wherein
the control unit is configured so that the address whose attribute information has been changed from pinned to unpinned is associated with attribute information indicating the change in the management table, and
the control unit is configured to preferentially record, in the disk-shaped recording medium, data in the area on the nonvolatile memory corresponding to the address associated with the attribute information indicating that the attribute information has been changed from pinned to unpinned.

3. An information recording apparatus according to claim 1, wherein
the control unit is configured to associate attribute information indicating that access date is oldest in the management table with the address whose attribute information has been changed from pinned to unpinned, and
the control unit is configured to preferentially record, in the disk-shaped recording medium, data in the area on the nonvolatile memory corresponding to the address associated with the attribute information indicating that the access date is oldest among the addresses to which the unpinned attribute information is added.

4. An information recording apparatus according to claim 1, wherein
the control unit is configured to execute a function of changing the address with which the pinned attribute information is associated so that the unpinned attribute information is associated with this address when the disk-shaped recording medium is not rotating or is about to stop rotating.

5. An information recording apparatus according to claim 1, wherein
the control unit is configured to record, in the disk-shaped recording medium, data in the area on the nonvolatile memory associated with the address to which the pinned attribute information is associated among the specified addresses in the management table when the disk-shaped recording medium is rotating, on the basis of the command from the host which requests to specify addresses and cancel the pinned attribute information.

6. An information recording apparatus according to claim 1, wherein
the control unit is configured to record, in the disk-shaped recording medium, data in the area on the nonvolatile memory corresponding to the address to which the unpinned attribute information is associated in the nonvolatile memory when a free area in the nonvolatile memory has reached a predetermined capacity set in advance.

7. An information recording apparatus according to claim 1, wherein
the disk-shaped recording medium is a hard disk, and the nonvolatile memory is a flash memory.

8. A method of controlling an information recording apparatus which includes: an input unit to which a command is input; a disk-shaped recording medium; and a nonvolatile memory serving as a cache memory for the disk-shaped recording medium, the method comprising:
creating a management table wherein an area on the nonvolatile memory is allocated to an address indicated by a host to read from or write into the nonvolatile memory, the address indicated by the host is associated with pinned attribute information in the allocated area on the nonvolatile memory, an area on the nonvolatile memory is allocated to an address which is not associated with the pinned attribute information with regard to some or all commands in which the address indicated to read or write is not associated with the pinned attribute information among commands issued from the host to request reading or writing, and the address indicated by the command issued from the host to request reading or writing is associated with unpinned attribute information in the allocated area on the nonvolatile memory;
recording, in the disk-shaped recording medium with predetermined timing, part or all of data in the area with which the unpinned attribute information is associated in the nonvolatile memory; and
changing an address with which the pinned attribute information is associated out of the specified addresses in the management table so that the unpinned attribute information is associated with this address, on the basis of a command from the host which requests to specify addresses and cancel the pinned attribute information.

9. A method according to claim 8, wherein
the changing includes causing the address whose attribute information has been changed from pinned to unpinned to be associated with attribute information indicating the change in the management table, and
the recording includes preferentially recording, in the disk-shaped recording medium, data in the area on the nonvolatile memory corresponding to the address associated with the attribute information indicating that the attribute information has been changed from pinned to unpinned.

10. A method according to claim 8, wherein
the changing includes associating attribute information indicating that access date is oldest in the management table with the address whose attribute information has been changed from pinned to unpinned, and
the recording includes preferentially recording, in the disk-shaped recording medium, data in the area on the nonvolatile memory corresponding to the address associated with the attribute information indicating that the access date is oldest among the addresses to which the unpinned attribute information is assigned.

11. A method according to claim 8, wherein
the changing includes executing a function of changing the address with which the pinned attribute information is associated so that the unpinned attribute information is associated with this address when the disk-shaped recording medium is not rotating or is about to stop rotating.

12. A method according to claim 8, wherein
the changing includes recording, in the disk-shaped recording medium, data in the area on the nonvolatile memory associated with the address to which the pinned attribute information is associated among the specified addresses in the management table when the disk-shaped recording medium is rotating, on the basis of the command from the host which requests to specify addresses and cancel the pinned attribute information.

13. A method according to claim 8, wherein
the recording includes recording, in the disk-shaped recording medium, data in the area on the nonvolatile memory corresponding to the address to which the unpinned attribute information is associated in the nonvolatile memory when a free area in the nonvolatile memory has reached a predetermined capacity set in advance.
